(19) United States
(12) Patent Application Publication
(10) Pub. No.: US 2025/0249667 A1
(43) Pub. Date: Aug. 7, 2025

(54) THIN MULTILAYER POLYMER FILMS FORMED FROM POST-CONSUMER RECYCLING MATERIALS AND METHODS OF FORMING SAME

(71) Applicant: Revolution Sustainable Solutions, Little Rock, AR (US)

(72) Inventors: Natarajan S. Ramesh, Midlothian, VA (US); Tim Shambro, West Monroe, LA (US); Michael Isbell, Carlisle, AR (US)

(21) Appl. No.: 18/810,165

(22) Filed: Aug. 20, 2024

Related U.S. Application Data
(60) Provisional application No. 63/549,741, filed on Feb. 5, 2024.

(51) Int. Cl. B32B 27/08; B32B 3/04; B32B 27/32

(52) U.S. Cl. CPC B32B 27/08; B32B 3/04; B32B 27/32; B32B 2250/242; B32B 2272/00; B32B 2307/30; B32B 2307/4026; B32B 2307/54; B32B 2307/5825; B32B 2307/72; B32B 2307/7376; B32B 2439/06

(57) ABSTRACT

Thin multilayer films fabricated from molten blends of stock plastic resin and post-consumer recycled plastic materials are described. The thin multilayer films maintain robust physical and mechanical properties as compared to thin films fabricated from stock plastic resins and as compared to prior art multilayer films that incorporate PCR plastic materials. Generally, the thin multilayer films with post-consumer recycled plastic maintain at least 70% of the value of a mechanical property when compared to film without the post-consumer recycled plastic material. The multilayer film may contain about 60% post-consumer recycled plastic materials yet maintain structural integrity. The multilayer film may include white or unpigmented post-consumer recycled plastic materials or a blend of white and unpigmented post-consumer recycled plastic material.

### RELATED APPLICATION

This application claims benefit of U.S. Provisional Application Ser. No. 63/549,741, filed Feb. 5, 2024, the contents of which are hereby incorporated by reference in their entirety.

### FIELD OF INVENTION

The present disclosure generally relates to thin multilayer polymer films formed from polymer blends that include post-consumer recycled materials and methods of forming such films. More specifically, the present disclosure relates to thin multilayer polymer films formed from polymer blends that include post-consumer recycled materials, where the melt flow index of the blends is relatively high, more than one post-consumer recycled material is used, and the mechanical properties of the resulting films are improved.

### BACKGROUND

Recycling programs, both voluntary and government mandated, have greatly increased the volume of available recycled materials over the last couple of decades. This is a trend that is sure to continue in the future. This is particularly true for plastics and other polymer materials. In 2021, approximately five billion pounds of post-consumer recycled (PCR) plastic materials were collected in the United States. This is an increase of over five percent compared to 2020. The latest information estimates that the PCR plastic market in 2023 in the United States is approximately 62.1 billion dollars and is projected to grow to 92.6 billion dollars by 2028. This growth is in part fueled by government regulation. For example, many U.S. states, such as California, Washington, New Jersey, and Maine, have new regulations that mandated that certain consumer products will be required to be manufactured using a certain percentages of PCR plastic material. For example, the state of Washington has enacted regulations that require all current trash bags to include 10% PCR plastic, with the percentage increasing to 15% in 2025, and increasing again to 20% in 2027. Similarly, New Jersey has enacted regulations that require plastic trash bags to contain 5-20% PCR plastic in 2024 and 10-40% PCR plastic in 2027 (with the applicable percentage depending on thickness of the trash bag). In addition to government regulations, manufacturers may find economic incentives to use PCR plastic materials. As more and more PCR materials are collected, the price of such materials may fall below standard manufactured polymer resins, which will make PCR materials economically appealing. Finally, many corporations and organizations are engaging in good-governance and sustainability initiatives that encourage and promote the use of recycled materials. This is true for both companies that manufacture products as well as companies that purchase products. Such initiatives will increase the use of PCR plastic materials in the manufacturing industry to satisfy internal policies or customers' policies.

To date, the one drawback of using PCR plastic materials in the manufacture of plastic products is that the incorporation of PCR plastics can degrade the physical and mechanical properties of the resulting product. For plastic products that rely on robust mechanical properties, it can be a significant technical hurdle to incorporate PCR plastic materials as an ingredient in the manufacturing process. In one example, plastic trash bags rely on robust mechanical properties to adequately perform its purpose. As a plastic trash bag is packed with rubbish, the trash bag can be significantly stretched, which subjects the trash bag to potential tearing. Thus, having a robust tear strength that resists tearing under normal use conditions is a requirement for a quality trash bag. However, prior art methods of adding PCR plastic materials to trash bags have significantly reduced the tear strength of the trash bags, which makes is difficult or impossible to make a quality plastic bag while meeting certain government regulations and corporate policies that require trash bags to be made from a certain percentage of PCR plastic materials.

This disclosure describes and illustrates certain embodiments of thin multilayer plastic films suitable for use to fabricate trash bags that incorporate significant amounts of PCR plastic materials while maintaining the physical properties, such as tear strength, required for a quality trash bag.

### SUMMARY

Disclosed herein are embodiments of thin multilayer films suitable for use as structural materials for the fabrication of numerous articles and films. The thin multilayer films include significant PCR plastic material content, and the PCR plastic materials are blended with standard plastic resins to form layers of the multilayer film. Such thin multilayer films can include between 20% and 90% by weight percent of PCR plastic materials, with overall thickness from about 0.2 mils to about 10 mils. The thin multilayer films can be any number of layers, including three layers, five layers, seven layers, etc. Individual layers can include no PCR plastic material, significant amounts of one type of PCR plastic material, or significant amounts of more than one type of PCR plastic material. The standard plastic resins and the PCR plastic materials can include different melt flow indexes; however, the blends of such material typically have a melt flow index of 0.6 g/10 min at 190° C./2.16 kg (as tested in accordance with ASTM D1238) or greater, and preferably a melt flow index of 1.0 g/10 min at 190° C./2.16 kg (as tested in accordance with ASTM D1238) or greater. It is noted that all values of melt flow index cited herein are tested in accordance with ASTM D1238. The thin multilayer films include robust mechanical properties, particularly tear strength. Such mechanical properties are particularly robust in comparison to tear strengths of prior art thin films formed with significant PCR plastic material content and the tear strengths are comparable to thin films made of 100% virgin polymer resin.

In one embodiment, a three layer film includes two skin layers and a middle layer. The skin layers are fabricated from polyethylene resin with a melt flow index of approximately 0.9 g/10 min at 190° C./2.16 kg. The middle layer is fabricated from a 50%/50% blend of polyethylene resin with a melt flow index of approximately 2.0 g/10 min at 190° C./2.16 kg and a PCR plastic material with a melt flow index of about 0.47 g/10 min at 190° C./2.16 kg. The middle layer is about three times the thickness of each skin layer, which yields a PCR plastic material content of approximately 30%. Such a thin multilayer film has a tear strength that is several times higher than tear strength for prior art thin multilayer films with 30% PCR plastic material content, and a tear strength that is 82% of the tear strength of a thin three-layer film fabricated from 100% polyethylene resin.

In another embodiment, a three layer film includes two skin layers and a middle layer. The skin layers are fabricated from polyethylene resin with a melt flow index of approximately 0.9 g/10 min at 190° C./2.16 kg. The middle layer is fabricated from a 50%/25%/25% blend of polyethylene resin used for the skin layers; a first PCR plastic material with a melt flow index of about 0.47 g/10 min at 190° C./2.16 kg; and a second PCR plastic material with a melt flow index of about 1.54 g/10 min at 190° C./2.16 kg. The middle layer is about three times the thickness of each skin layer, which yields a PCR plastic material content of approximately 30%. Such a thin multilayer film has a tear strength that is several times higher than tear strength for prior art thin multilayer films with 30% PCR plastic material content, and a tear strength that is 89% of the tear strength fabricated from 100% polyethylene resin.

In yet another embodiment, a three layer film includes two skin layers and a middle layer. The skin layers are fabricated from polyethylene resin with a melt flow index of approximately 0.9 g/10 min at 190° C./2.16 kg. The middle layer is fabricated from a 30%/35%/35% blend of polyethylene resin used for the skin layers; a first PCR plastic material with a melt flow index of about 0.47 g/10 min at 190° C./2.16 kg; and a second PCR plastic material with a melt flow index of about 1.54 g/10 min at 190° C./2.16 kg. The middle layer is about three times the thickness of each skin layer, which yields a PCR plastic material content of approximately 42%. Such a thin multilayer film has a tear strength that is several times higher than tear strength for prior art thin multilayer films with 42% PCR plastic material content, and a tear strength that is 86% of the tear strength fabricated from 100% polyethylene resin.

### BRIEF DESCRIPTION OF THE DRAWINGS

In the accompanying drawings, structures are illustrated that, together with the detailed description provided below, describe example embodiments of the disclosed apparatus and methods. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 is a graph depicting tear strength in the machine direction for samples of thin multilayer films with different PCR plastic content.

### DETAILED DESCRIPTION

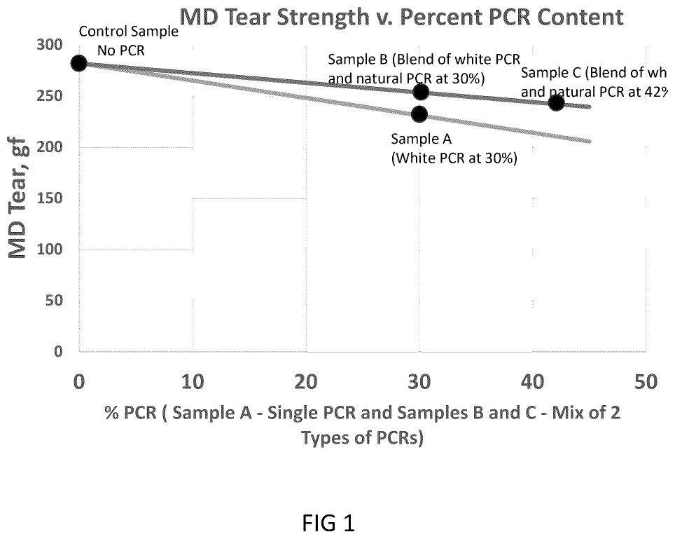

The apparatus, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of thin multilayer films formed in part from PCR plastic materials and methods of forming such films are hereinafter disclosed and described in detail with reference made to FIG. 1.

Disclosed herein are exemplary embodiments of thin multilayer films fabricated from molten blends of stock plastic resin and PCR plastic materials. The thin multilayer films disclosed and described herein maintain robust physical and mechanical properties as compared to thin films fabricated from stock plastic resins and as compared to prior art multilayer films that incorporate PCR plastic materials. Generally, when comparing thin multilayer films with PCR plastic content to thin films fabricated from stock plastic resin, it is preferable that the thin multilayer films with PCR plastic content maintain at least 70% of the value of a mechanical property when compared to the thin multilayer films fabricated from stock polymer resin. As will be further discussed, the exemplary embodiments disclosed herein do generally maintain at least 70% of the value for mechanical properties in comparison to films fabricated from stock plastic resin. Prior art thin multilayer films fabricated with PCR plastic materials generally maintain a very low percentage of the value of mechanical properties as compared to stock plastic resin films. For example, with regard to tear strength in the machine direction, prior art multilayer films with 10-20% PCR plastic content typically maintain a tear strength in the range of 40-50% of value as compared to stock plastic resin film; prior art multilayer films with 25-35% PCR plastic content maintain a tear strength in the range of 15-25% of value as compared to stock plastic resin film; and prior art multilayer films with 40-50% PCR plastic content maintain a tear strength in the range of 12-20% of value as compared to stock plastic resin film.

Certain embodiments disclosed herein include three layer—a middle layer sandwiched by two skin layers. However, these arrangements are exemplary and other arrangements can include five layers, seven layer, or any other number of layers and still practice the principles disclosed herein. Additionally, certain embodiments will include specific percentages and types of PCR plastic materials added to certain layers. However, other percentages or types of PCR plastic materials can be used while practicing the principles disclosed herein. Specifically, in the embodiments disclosed herein, the PCR plastic materials are added to the middle layer of the thin multilayer films; however, PCR plastic materials can also be added to the skin layers. The embodiments described herein use specific stock plastic resins and PCR plastic materials. However, other stock plastic resins and PCR plastic materials can be used such as, but not limited to, polyolefins such as any variety of polyethylene, polypropylene metallocene, or polyolefin copolymers.

As described herein, various thin multilayer films were fabricated and tested to demonstrate the effects on physical and mechanical properties on the multilayer film caused by the addition of different types of PCR plastic materials to certain layers of the film and at different percentages. In addition to comparing mechanical properties of various PCR plastic containing samples, a control sample, containing no PCR plastic is prepared. All sample, including the control sample, are processed under the same conditions and parameters. The materials used to form the samples are: a linear low-density polyethylene (LLDPE), hexene-linear low-density polyethylene (hex-LLDPE), a linear low-density polyethylene with a high melt flow index (LLDPE-HMFI); a slip additive, a PCR plastic recycled from white pigmented plastics (“white PCR”), and a PCR plastic recycled from unpigmented plastics that will be subsequently described in detail (“natural PCR”).

The linear low-density polyethylene (LLDPE) is stock plastic resin made from natural material (i.e., “virgin” material) with a density of 0.918 g/cc and melt flow index of about 0.9 g/10 min at 190° C./2.16 kg. The LLDPE-HMFI is stock plastic resin made from natural material with a density of 0.918 g/cc and melt flow index of about 2.0 g/10 min at 190° C./2.16 kg. The slip additive is a highly filled calcium carbonate concentrate added to manage the coefficient of friction and enhance processing of the plastic by reducing plastic sticking to processing equipment. The white PCR plastic is recycled mainly from rigid material such as pipes made from polyethylene. Such pipes are typically ground up to form granules that can be used directly or blended with other resins and melted to use in molding process. The white PCR plastic has a melt flow index of about 0.3 to 0.6 g/10 min at 190° C./2.16 kg. The natural PCR plastic is recycled mainly from linear low-density polyethylene (LLDPE) stretch wrap material commonly used in the packaging and transportation industries. Such materials, while unpigmented, after use in packaging may become hazy or slightly opaque and often take on a tan or grayish appearance. The natural PCR plastic has a melt flow index of about 1.54 g/10 min at 190° C./2.16 kg.

The materials described above can be blended such that the melt flow index is controlled. Generally, blends with a higher melt flow index yield better mechanical properties. Additionally, the morphologies of the PCR plastic materials can be leveraged to produce better mechanical properties, particularly by blending two distinct morphologies. The white PCR material is generally recycled from structural components such as piping. During the initial fabrication of such piping, an extrusion processes is used to make pipes, which yields a generally randomly distributed of polymer chains. For the natural PCR material, when the underlying stretch wrap material is fabricated, a tensile force is applied, which causes systematic orientation to the polymer chains. Additionally, the manner in which the stretch wrap material is used (i.e., stretched around boxes, products, and other cargo for long periods of time during shipping and storage), can further induce systematic orientation of polymer chains. This systematic orientation induces viscoelastic forces in the stretch wrap material, and it appears that the natural PCR materials and the resulting thin multilayer films that include natural PCR materials retain a residual memory of the polymer chain orientation and viscoelastic forces. This residual memory of polymer chain orientation appears to improve mechanical properties of thin multilayer films. Additionally, there appears to be some synergy when white PCR material with a random distribution of polymer chains is blended with natural PCR with oriented polymer chains to improve mechanical properties.

According to one aspect of the invention, the multilayer film is made of at least two layers. The film having at least one skin layer that is a polyolefin having a density of from about 0.850 g/cc to 0.950 g/cc and a melt index of from about 0.5 g to about 3 g/10 min at 190° C./2.16 kg, and a second layer that is a core layer comprising post-consumer recycled (PCR) low density polyethylene polymer. Multilayer films produced according to this aspect of the invention have an overall post-consumer recycled content of the multilayer film ranges from 20% to 90% and an overall film thickness of the multilayer film ranges from about 0.2 mil to 10 mils.

According to some aspect of the invention, the materials used to form the multilayer film are linear low-density polyethylene (LLDPE), hexene linear low-density polyethylene (hex-LLDPE), a linear low-density polyethylene with a high melt flow index (LLDPE-HMFI), a slip additive, a PCR plastic recycled from white pigmented plastics, and a PCR plastic recycled from unpigmented plastics. Various types of LLDPEs are described in the Handbook of Industrial Polyethylene Technology, Part One Edited by Mark A. Spalding and Ananda M. Chatterjee, Scrivener Publishing LLC (2018)-Handbook of Industrial Polyethylene and Technology| Wiley Online Books. All LLDPEs as described in this handbook may be applied to the methods and articles described herein. Further it is appreciated that emerging LLDPEs and new catalyzed technologies for production of LLDPE are under development. Use of such LLDPEs is envisioned as an aspect of the invention.

According to some aspect of the invention, the materials used to form the multilayer film are a low-density polyethylene, a metallocene catalyzed polyethylene (mPE), a linear low-density polyethylene (LLDPE), a low-density polyethylene (LDPE), a medium-density polyethylene (MDPE), a high-density polyethylene (HDPE), a virgin polyolefin copolymers, a post-consumer recycled polyethylene polymer, or a postindustrial recycled polyethylene polymer, hexene linear low-density polyethylene (hex-LLDPE), a linear low-density polyethylene with a high melt flow index (LLDPE-HMFI), a PCR plastic recycled from white pigmented plastics, and a PCR plastic recycled from unpigmented plastics.

According to some aspects of the invention a co-mononmer hexene is used in the examples, one can also use other comonomer based polyolefin such as butene or octene based polyolefins or their blends. LLDPE normally means a random copolymer of ethylene and alpha-olefin selected from the group consisting of C3 to C10 alpha-olefins having a polymerized alpha-olefin content of about 20% by weight. Examples of suitable alpha-olefin monomers in the LLDPE resin include, but are not limited to, butene, pentene, methyl-pentene, hexene, heptene, octene, and 1,4-butadiene. The LLDPE used in connection with the invention typically will be a copolymer of ethylene and butene. According to one aspect of the invention, hexene LLDPE may be used alone or in combination with butene, octene or other comonomers

According to some aspects of the invention, suitable resins are those polyethylenes other than LDPE and copolymers and terpolymers prepared with ethylene monomers and oligomers. These resins include, but are not limited to, the polyethylenes normally considered to be linear, including ethylene homopolymer, the ethylene and alpha-olefin copolymers normally designated as polyethylenes, and the copolymers of ethylene with the bulkier monomers. These resins present the problem of low melt strength and extensional viscosity and previously have been generally regarded as incompatible with LDPE and unsuitable for making stable foams. The polyethylene resins include high density polyethylene (HDPE), ultra-high density polyethylene (UHDPE), linear medium density polyethylene (LMDPE), linear low density polyethylene (LLDPE), very low density polyethylene (VLDPE), ultra-low density polyethylene (ULDPE), metallocene polyethylene (mPE), which is produced from metallocene catalyzed polymerization. The alpha-olefins normally have from 3 to 20 carbon atoms in the chain and include propene, 1-butene, 1-pentene, 1-hexene, 1-octene, methyl pentene, and the like. Also included are various ethlyenic copolymers including, but not limited to, ethylene monomers or oligomers copolymerized or block polymerized with vinyl acetate (ethylene vinyl acetate or EVA); methyl methacrylate; maleic anhydride; acrylonitrile; alpha-olefins including propylene, butylene, methyl pentene; isoprene; styrene; acrylic acid; and ionic salts of acrylic acid (ionomers). These various ethylenic polymers can be used alone, in admixture, and as blends with conventional low density polyethylene (LDPE). All these ethlyenic polymers normally also are considered linear, excluding LDPE, even though they may contain some degree of short and long chain branching.

Metallocene catalyzed polyolefins that can be mixed with LLDPE as additives to improve toughness and MD tear properties, For example, resins such as Exxon's Exceed and Enable resins (Silage and silo bag films 1 ExxonMobil Product Solutions (exxonmobilchemical.com)) & Dow Elite and Dowlex resins (ELITE™ 5230 G Enhanced Polyethylene Resin| Dow Inc.; DOWLEX™ 2036G Polyethylene Resin| Dow Inc.)

Ultra-low density polyethylene normally designates linear polymers of density from about 0.86 to 0.88 g/cc. Very low density polyethylene normally designates linear polymers of density from about 0.88 to 0.91 g/cc. Linear low density polyethylene normally designates linear polymers of density from about 0.91 to 0.93 g/cc. Linear medium density polyethylene normally designates linear polymers of density from about 0.93 to 0.94 g/cc. High density polyethylene normally designates linear polymers of density from about 0.94 to 0.96 g/cc. Ultra-high density polyethylene normally designates linear polymers of density greater than about 0.96 g/cc. Metallocene polyethylene normally designates linear polymers having densities of from about 0.86 to 0.95 g/cc (mPE). According to one aspect of the invention, LDPEs with a density in the range of about 0.85 g/cc to about 0.97 g/cc is encompassed. According to one aspect of the invention, LDPEs with a density in the range of 0.85 g/cc to 0.97 g/cc is encompassed. Further, according to one aspect of the invention, an LDPE with a density that is a single numerical value within this range is encompassed by the invention. According to one aspect of the invention, LDPEs with a density in the range of 0.85 g/cc to 0.967 g/cc is encompassed. According to one aspect of the invention, LDPEs with a density in the range of 0.87 g/cc to 0.950 g/cc is encompassed. According to one aspect of the invention, LDPEs with a density in the range of 0.915 g/cc to 0.950 g/cc is encompassed.

According to some aspects of the invention, the multilayer film comprises three layers, wherein first and third skin layers surround and enclose a second, core layer. In such a configuration, the second, core layer of post-consumer recycled linear low density polyethylene polymer having at least 0.25 melt flow index (MFI).

According to some aspect of the invention, the multilayer film has first and third skin layers that are each about 0.2 mils in thickness and the core layer is about 0.6 mils in thickness so that the multilayer film is about 1.0 mils in thickness.

According to some aspect of the invention, the core layer is characterized by between about 20% and 100% post-consumer recycled (PCR) content. That is, the core layer may be made entirely of PCT content or may be a mixture of PCR content with other polyethylene polymers present. The result of the core layer having between about 20% and 100% post-consumer recycled (PCR) content is that the multilayer film as a whole comprises between about 30% and 60% post-consumer recycled (PCR) content. Importantly the films with such a substantial amount of PCR content are comparable in durability to multilayer films with no PCT content.

According to some aspect of the invention, the core layer is characterized by a mixture of PCR plastic recycled from white pigmented plastics, and a PCR plastic recycled from unpigmented plastics. According to some aspect of the invention, the core layer may contain a mixture of about 50% PCR plastic recycled from white pigmented plastics, and about 50% PCR plastic recycled from unpigmented plastics.

According to some aspect of the invention, the number of layers in the multilayer film is not particularly limited. That is, there are aspects of the invention where the films have five layers: first and third skin layers surround a second, core layer comprising post-consumer recycled linear low density polyethylene polymer and the third and fifth skin layers surround a fourth, core layer comprising post-consumer recycled linear low density polyethylene polymer. Further, there are aspects of the invention where the films have seven layers and first and third skin layers surround a second, core layer comprising post-consumer recycled linear low density polyethylene polymer, the third and fifth skin layers surround a fourth, core layer comprising post-consumer recycled linear low density polyethylene polymer; and the fifth and seventh skin layers surround a sixth, core layer comprising post-consumer recycled linear low density polyethylene polymer.

According to some aspect of the invention, any articles may be formed from the multilayer film as described. The article may be a trash bag, a pouche, a sachet, a consumer film, non-food and food packaging, an agricultural film, a greenhouse films, a silage or grain films, a mulch film, a grape film, a almond film, a poly pipe for irrigation, a geomembrane, a pond liner or a bunker cover

According to some aspect of the invention, a method of making a multilayer film is described. The films made according to the method have at least two layers. The films made according to the method may be characterized by a skin layer comprising a polyolefin having a density of from about 0.850 g/cc to 0.950 g/cc and a melt index of from about 0.5 g to about 3 g/10 min at 190° C./2.16 kg, and a core layer of between about 20% to about 100% post-consumer recycled (PCR) low density polyethylene polymer. The method according to some aspect of the invention is a blown film process.

According to some aspect of the invention, the films made according to the method include a linear low-density polyethylene (LLDPE), a linear low-density polyethylene with a high melt flow index (LLDPE-HMFI), a slip additive, a PCR plastic recycled from white pigmented plastics, and a PCR plastic recycled from unpigmented plastics.

According to some aspect of the invention, the films made according to the method have three layers, wherein first and third skin layers surround and enclose a second, core layer and the blown film process comprises a three-layer coextrusion blown film process.

According to some aspect of the invention, the films made according to the method have first and third skin layers are each about 0.2 mils in thickness and the core layer is about 0.6 mils in thickness so that the multilayer film is about 1.0 mils in thickness.

According to some aspect of the invention, the films made according to the method have a second, core layer comprises between about 20% and 100% post-consumer recycled (PCR) content so that the multilayer film made by this method have between about 30% and 60% post-consumer recycled (PCR) content.

According to some aspect of the invention, the films made according to the method have a core layer that is a mixture of about 50% PCR plastic recycled from white pigmented plastics, and about 50% PCR plastic recycled from unpigmented plastics.

### Examples

Multiple three layer samples including no PCR plastics (to be referred to as “Control Sample”) are formed as follows. A first skin layer is formed from 94% hex-LLDPE and 6% slip additive. This first skin layer is approximately 0.20 mils in thickness (i.e., 0.00020 inches, 1 mil is equal to 0.001 inches). A second skin layer is formed from 100% hex-LLDPE and is approximately 0.20 mils in thickness. A middle layer is formed from 100% hex-LLDPE and is approximately 0.60 mils in thickness. Once each film is fabricated, they are combined into the three layer sample. On average, the thickness of the three layer control samples is 0.958 mils.

Multiple three layer samples including 30% PCR plastics (to be referred to as “Sample A”) are formed as follows. A first skin layer is formed from 94% hex-LLDPE and 6% slip additive and is approximately 0.20 mils in thickness. A second skin layer is formed from 100% hex-LLDPE and is approximately 0.20 mils in thickness. A middle layer is formed from 50% LLDPE-HMFI and 50% white PCR plastic and is approximately 0.60 mils in thickness. Once each film is fabricated, they are combined into the three layer sample. On average, the thickness of the three layer control samples is 0.955 mils.

Multiple three layer samples also including 30% PCR plastics (to be referred to as sample B) are formed as follows. A first skin layer is formed from 94% hex-LLDPE and 6% slip additive and is approximately 0.20 mils in thickness. A second skin layer is formed from 100% hex-LLDPE and is approximately 0.20 mils in thickness. A middle layer is formed from 50% hex-LLDPE, 25% white PCR plastic, and 25% natural-PCR plastic. The approximate thickness of the middle layer is 0.60 mils. Once each film is extruded, they are combined into the three layer sample. On average, the thickness of the three layer control samples is 0.965 mils. In contrast to Sample A, Sample B's 30% PCR plastic content is split evenly between white PCR plastic and natural PCR plastic.

Multiple three layer samples including 42% PCR plastics (to be referred to as “Sample C”) are formed as follows. A first skin layer is formed from 94% hex-LLDPE and 6% slip additive and is approximately 0.20 mils in thickness. A second skin layer is formed from 100% hex-LLDPE and is approximately 0.20 mils in thickness. A middle layer is formed from 30% hex-LLDPE, 35% white PCR plastic, and 35% natural PCR plastic. The approximate thickness of the middle layer is 0.60 mils. Once each film is fabricated, they are combined into the three layer sample. On average, the thickness of the three layer control samples is 0.957 mils.

Once the above described samples were prepared, the samples were subjected to various mechanical testing to determine the quality of the material for use as a trash bag. The tests include tear strength in both the “machine direction” (MD tear strength) and “transvers direction” (TD tear strength); tensile strength in both the machine direction (MD tensile strength) and transverse direction (TD tensile strength); strain at break in both the machine direction (MD strain) and the transverse direction (TD strain); and a dart drop test (dart drop). The machine direction is the direction the material is processed in the fabrication process. The transverse direction is the direction that is perpendicular to the machine direction. The dart drop test is used to determine a material's resistance to puncture. A square or rectangular sample of the material to be tested is laid horizontally and securely clamped on four sides. Several bolts of different weights, each with the same rounded leading edge, are dropped from a distance. The dart testing using the staircase technique outlined in ASTM 1709-09 test method.

MD tear strength results of the testing are illustrated in the graph of FIG. 1 (charting MD tear strength versus percentage of PCR in sample). Additional mechanical testing is summarized in the tables below (listed several values for mechanical testing for samples).

FIG. 1 illustrates raw values for MD tear strength in units of gram-force. The average MD tear strength for Control Samples is 270 gf; the average MD tear strength for Sample A is 221 gf; the average MD tear strength for Sample B is 243 gf; and the average MD tear strength for Sample C is 232 gf. Table 1 below, normalizes these values based on thickness of the samples. Sample A, with 50% white PCR in the middle layer, and 30% overall PCR content, shows a drop of 18.1% in MD tear strength compared to 100% hex-LLDPE Control Samples. Sample B, with 25% white PCR and 25% natural PCR in the middle layer, and 30% overall PCR content, shows an improvement over Sample A with a reduction of 10.9% in MD tear strength compared to 100% hex-LLDPE Control Samples. Sample C, with 35% white PCR and 35% natural-PCR in the middle layer, and 42% overall PCR content, shows a drop of 14.0% in MD tear strength compared to 100% hex-LLDPE Control Samples. All three samples sets maintain at least 70% of the value of MD tear strength when compared to the Control Samples. Additionally, all three sample sets demonstrate a significant improvement in MD tear strength as compared to prior art PCR containing films, which show drops of 50% to 88% compared to 100% non PCR samples.

TABLE 1

| | % | Avg. Thickness | MD Tear in | Comparison to |
|---|---|---|---|---|
| Sample | PCR | in Mils | gf/mil | Control Samples |
| Control Sample | 0% | 0.958 | 282 | N\|/A |
| Sample A | 30% | 0.955 | 231 | 18.1% |
| Sample B | 30% | 0.965 | 252 | 10.9% |
| Sample C | 42% | 0.957 | 243 | 14.0% |

Table 2 below lists values for TD tear strength for the samples. The testing demonstrates that the TD tear strength actually improves with each of Samples A, B, and C. Sample B demonstrates a significant improvement of 16.7% over the Control Sample, and Samples

A and C demonstrate slight improvements over the Control Samples.

TABLE 2

| | % | Avg. Thickness | TD Tear | Comparison to |
|---|---|---|---|---|
| Sample | PCR | in Mils | in gf/mil | Control Samples |
| Control Sample | 0% | 0.958 | 601 | N\|/A |
| Sample A | 30% | 0.955 | 604 | +0.6% |
| Sample B | 30% | 0.965 | 701 | +16.7% |
| Sample C | 42% | 0.957 | 616 | +2.6% |

Table 3 below lists values for MD tensile strength for the samples. The testing demonstrates that the MD tensile strength is marginally reduced in Samples A, B, and C as compared to the Control Samples and well within the 70% threshold.

TABLE 3

| | | | MD Tensile | |
|---|---|---|---|---|
| | % | Avg. Thickness | Strength | Comparison to |
| Sample | PCR | in Mils | in lbf | Control Samples |
| Control Sample | 0% | 0.958 | 10.4 | N\|/A |
| Sample A | 30% | 0.955 | 9.9 | 5.1% |
| Sample B | 30% | 0.965 | 9.5 | 8.4% |
| Sample C | 42% | 0.957 | 9.3 | 11.1% |

Table 4 below lists values for TD tensile strength for the samples. The testing demonstrates that the TD tensile strength for Sample A is marginally reduced compared to the Control Samples. The TD tensile strength for Samples B is well within acceptable range and TD tensile strength for Sample C is marginally outside the acceptable range.

TABLE 4

| | | | TD Tensile | |
|---|---|---|---|---|
| | % | Avg. Thickness | Strength | Comparison to |
| Sample | PCR | in Mils | in lbf | Control Samples |
| Control Sample | 0% | 0.958 | 7.8 | N\|/A |
| Sample A | 30% | 0.955 | 7.3 | 5.9% |
| Sample B | 30% | 0.965 | 6.3 | 19.0% |
| Sample C | 42% | 0.957 | 4.9 | 36.5% |

Table 5 below lists values for the dart drop testing for the samples. The values are normalized based on thickness. The testing demonstrates that the dart drop values for Samples A,

B, and C are comparable to the Control Samples with marginal differences in the values.

TABLE 5

| | % | Avg. Thickness | Dart Drop | Comparison to |
|---|---|---|---|---|
| Sample | PCR | in Mils | in g/mil | Control Samples |
| Control Sample | 0% | 0.958 | 144 | N\|/A |
| Sample A | 30% | 0.955 | 138 | 4.0% |
| Sample B | 30% | 0.965 | 141 | 1.8% |
| Sample C | 42% | 0.957 | 143 | 1.0% |

Table 6 below lists values for MD strain at break for the samples. The testing demonstrates that Samples A and C are within the acceptable range, and the MD strain for Sample

B is marginally outside the acceptable range.

TABLE 6

| | | | MD Strain | |
|---|---|---|---|---|
| | % | Avg. Thickness | at Break as | Comparison to |
| Sample | PCR | in Mils | a percentage | Control Samples |
| Control Sample | 0% | 0.958 | 783% | N\|/A |
| Sample A | 30% | 0.955 | 584% | 25.415% |
| Sample B | 30% | 0.965 | 514% | 34.355% |
| Sample C | 42% | 0.957 | 575% | 26.564% |

Table 7 below lists values for TD strain at break for the samples. The testing demonstrates that the TD strain for Samples A, B, and C are within the acceptable range.

TABLE 7

| | | | TD Strain | |
|---|---|---|---|---|
| | % | Avg. Thickness | at Break as | Comparison to |
| Sample | PCR | in Mils | a percentage | Control Samples |
| Control Sample | 0% | 0.958 | 777% | N\|/A |
| Sample A | 30% | 0.955 | 667% | 14.157% |
| Sample B | 30% | 0.965 | 667% | 14.157% |
| Sample C | 42% | 0.957 | 645% | 16.988% |

The data and results from the foregoing testing demonstrate that thin multilayer films can be made with a significant PCR plastic content while maintaining either comparable mechanical properties or acceptable mechanical properties as compared to thin multilayer films made from stock plastic resins.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

Another set of examples are provided to illustrate broader chemistry-based PCR made from mixing or blending of “white PCR” (as described earlier) with clear LLDPE/LDPE film-based post-consumer recycled (PCR) pellets. The average of 28 samples collected from LLDPE/LDPE film-based MFI (Melt Flow Index) is around 2.01. By combining this clear LLDPE/LDPE PCR with white PCR at 50/50 ratio through the melt blending extrusion process, the resulted melt blend produced MFI in the range between 0.982 to 1.029 MFI based on measurements made from 4 boxes of samples with 1200 lbs. each. The blending can be done in several ways: 1) physical blending of pellets; 2) feeding them from separate hoppers; 3) Melt blending in an extruder (single or twin or tandem type extruder). In this experiment, the melt blending was done in a long single screw extruder with appropriate mixing and screening elements to achieve homogeneity in the extruded PCR pellets. This melt blended PCR can be referred as “Rev PCR” for easy reference. It can be added into one or all layers of multilayered films. The hex-LLDPE is stock plastic resin made from natural material (i.e., “virgin” material) with a density of 0.918 g/cc and melt flow index of about 0.9 g/10 min at 190° C./2.16 kg. The slip additive is a highly filled calcium carbonate concentrate added to manage the coefficient of friction and enhance processing of the plastic by reducing plastic sticking to processing equipment. The white PCR plastic is recycled mainly from rigid material such as pipes made from polyethylene. Such pipes are typically ground up to form granules that can be used directly or blended with other resins and melted to use in molding process. The white PCR plastic has a melt flow index of about 0.3 to 0.6 g/10 min at 190° C./2.16 kg. The natural PCR plastic is recycled mainly from linear low-density polyethylene (LLDPE/LDPE) stretch wrap material commonly used in the packaging and transportation industries. Such materials, while unpigmented, after use in packaging may become hazy or slightly opaque and often take on a tan or grayish or other color appearance. The natural PCR plastic has a melt flow index of about 2.01 g/10 min at 190° C./2.16 kg for an average of 28 samples tested.

The materials described above can be blended such that the melt flow index is controlled. Generally, blends with a higher melt flow index yield better mechanical properties. Additionally, the morphologies of the PCR plastic materials can be leveraged to produce better mechanical properties, particularly by blending two distinct morphologies. The white PCR material is generally recycled from structural components such as piping. During the initial fabrication of such piping, an extrusion processes is used to make pipes, which yields a generally randomly distributed of polymer chains. For the natural PCR material, when the underlying stretch wrap material is fabricated, a tensile force is applied, which causes systematic orientation to the polymer chains. Additionally, the manner in which the stretch wrap material is used (i.e., stretched around boxes, products, and other cargo for long periods of time during shipping and storage), can further induce systematic orientation of polymer chains. This systematic orientation induces viscoelastic forces in the stretch wrap material, and it appears that the natural PCR materials and the resulting thin multilayer films that include natural PCR materials retain a residual memory of the polymer chain orientation and viscoelastic forces. This residual memory of polymer chain orientation appears to improve mechanical properties of thin multilayer films. Specifically, the PCR used here has a mixture of LLDPE and LDPE polymers. LLDPE has short branches whereas LDPE has more branching especially containing long chain branches. These long chain branches can create more molecular entanglement to offer bubble stability during blown film extrusion needed for good gauge control. Additionally, there appears to be some synergy when white PCR material with a random distribution of polymer chains is blended with natural PCR with oriented polymer chains to improve mechanical properties.

Multiple three-layer samples including no PCR plastics (to be referred to as “Control Sample”) are formed as follows. A first skin layer is formed from 94% hex-LLDPE and 6% slip additive. This first skin layer is approximately 0.20 mils in thickness (i.e., 0.00020 inches, 1 mil is equal to 0.001 inches). A second skin layer is formed from 100% hex-LLDPE and is approximately 0.20 mils in thickness. A middle layer is formed from 100% hex-LLDPE and is approximately 0.60 mils in thickness. Once each film is fabricated, they are combined into the three-layer sample. On average, the thickness of the three-layer control samples is 1.056 mils.

Multiple three-layer samples including 30% PCR plastics (to be referred to as “Sample A”) are formed as follows. A first skin layer is formed from 94% hex-LLDPE and 6% slip additive and is approximately 0.20 mils in thickness. A second skin layer is formed from 100% hex-LLDPE and is approximately 0.20 mils in thickness. A middle layer is formed from 50% hex-LLDPE and 50% Rev PCR plastic and is approximately 0.60 mils in thickness. Once each film is fabricated, they are combined into the three-layer sample. On average, the thickness of the three-layer control samples is 1.01 mils.

Multiple three-layer samples also including 45% PCR plastics (to be referred to as sample B) are formed as follows. A first skin layer is formed from 94% hex-LLDPE and 6% slip additive and is approximately 0.20 mils in thickness. A second skin layer is formed from 100% hex-LLDPE and is approximately 0.20 mils in thickness. A middle layer is formed from 25% hex-LLDPE, 75% Rev-PCR plastic which contains White PCR and Clear LLDPE/LDPE film-based PCR at 50/50 ratio. The approximate thickness of the middle layer is 0.60 mils. Once each film is extruded, they are combined into the three-layer sample. On average, the thickness of the three-layer control samples is 0.961 mils. In contrast to Sample A, Sample B's 45% Rev PCR plastic content is split evenly between white PCR plastic and natural LLDPE/LDPE film-based PCR plastic.

Multiple three-layer samples including 60% PCR plastics (to be referred to as “Sample C”) are formed as follows. A first skin layer is formed from 94% hex-LLDPE and 6% slip additive and is approximately 0.20 mils in thickness. A second skin layer is formed from 100% hex-LLDPE and is approximately 0.20 mils in thickness. A middle layer is formed from 100% Rev PCR which is a 50/50 melt blended white PCR plastic, and natural LLDPE/LDPE film-based PCR plastic. The approximate thickness of the middle layer is 0.60 mils. Once each film is fabricated, they are combined into the three-layer sample. On average, the thickness of the three-layer control samples is 0.957 mils.

Once the above-described samples were prepared, the samples were subjected to various mechanical testing to determine the quality of the material for use as a trash bag. The tests include tear strength in both the “machine direction” (MD tear strength) and “transvers direction” (TD tear strength); tensile strength in both the machine direction (MD tensile strength) and transverse direction (TD tensile strength); strain at break in both the machine direction (MD strain) and the transverse direction (TD strain); and a dart drop test (dart drop). The machine direction is the direction the material is processed in the fabrication process. The transverse direction is the direction that is perpendicular to the machine direction. The dart drop test is used to determine a material's resistance to puncture. A square or rectangular sample of the material to be tested is laid horizontally and securely clamped on four sides. Several bolts of different weights, each with the same rounded leading edge, are dropped from a distance. The dart testing using the staircase technique outlined in ASTM 1709-09 test method.

MD tear strength results of the testing are illustrated in the graph of FIG. 1 (charting MD tear strength versus percentage of PCR in sample). Additional mechanical testing is summarized in the tables below (listed several values for mechanical testing for samples).

FIG. 1 illustrates raw values for MD tear strength in units of gram-force. The average MD tear strength for Control Samples is 86 gf; the average MD tear strength for Sample A is 182 gf; the average MD tear strength for Sample B is 227 gf; and the average MD tear strength for Sample C is 219 gf. Table 8 below, normalizes these values based on thickness of the samples. Sample A, with 30% Rev PCR in the middle layer, and 30% overall PCR content, shows an increase 121% in MD tear strength compared to 100% hex-LLDPE Control Samples. Sample B, with 75% Rev PCR in the middle layer, and 45% (60% of 75% Rev PCR) overall PCR content, shows an improvement over Control with an increase of 190% in MD tear strength compared to 100% hex-LLDPE Control Samples. Sample C, with 100% Rev PCR and 35% in the middle layer, and 60% (100% of 60% core thickness) overall PCR content, shows an increase of 179% in MD tear strength compared to 100% hex-LLDPE Control Samples. All three samples sets exhibit much higher value of MD tear strength when compared to the Control Sample. Additionally, all three sample sets demonstrate a significant improvement in MD tear strength as compared to prior art PCR containing films, which show drops of 50% to 88% compared to 100% non-PCR samples. Generally, MD tear values tend to decrease with the increase in PCR content. Surprisingly, it is observed that MD tear is not only improved over Control Sample but also maintains it at higher PCR concentration above 30% all the way to 60%. This has a huge impact in commercial applications such as trash bags, pouches and mailers.

TABLE 8

| | % | Avg. Thickness | MD Tear in | Comparison to |
|---|---|---|---|---|
| Sample | PCR | in Mils | gf/mil | Control Samples |
| Control Sample | 0% | 1.056 | 81.4 | N\|/A |
| Sample A | 30% | 1.01 | 180.2 | +121% |
| Sample B | 45% | 0.961 | 236.2 | +190% |
| Sample C | 60% | 0.964 | 227.2 | +179% |

Table 9 below lists values for TD tear strength for the samples. The testing demonstrates that the TD tear strength actually improves with each of Samples A, B, and C. Sample A, B and C demonstrate significant improvements of % over the Control Sample ranging between 43 to 73%. Once again, this gives increased toughness in trash bag or pouch and mailer applications.

TABLE 9

| | % | Avg. Thickness | TD Tear | Comparison to |
|---|---|---|---|---|
| Sample | PCR | in Mils | in gf/mil | Control Samples |
| Control Sample | 0% | 1.056 | 488.6 | N\|/A |
| Sample A | 30% | 1.01 | 699 | +43% |
| Sample B | 45% | 0.961 | 843.9 | +73% |
| Sample C | 60% | 0.964 | 709.5 | +45% |

Table 10 below lists values for MD tensile strength for the samples. The testing demonstrates that the MD tensile strength is marginally reduced in Samples A, B, and C as compared to the Control Samples and well within the 70% threshold. For Sample B, the MD Tensile value increased by 5.3%.

TABLE 10

| | | | MD Tensile, | |
|---|---|---|---|---|
| | % | Avg. Thickness | peak load, | Comparison to |
| Sample | PCR | in Mils | lbf/in | Control Samples |
| Control Sample | 0% | 1.056 | 4.45 | N\|/A |
| Sample A | 30% | 1.01 | 3.03 | 31.9% |
| Sample B | 45% | 0.961 | 4.69 | +5.3% |
| Sample C | 60% | 0.964 | 4.4 | 1.1% |

Table 11 below lists values for TD tensile strength for the samples. The testing demonstrates that the TD tensile strength for Samples A to C is improved compared to the Control Samples.

TABLE 11

| | | | TD Tensile, | |
|---|---|---|---|---|
| | % | Avg. Thickness | peak load | Comparison to |
| Sample | PCR | in Mils | in lbf/inch | Control Samples |
| Control Sample | 0% | 1.056 | 1.7 | N\|/A |
| Sample A | 30% | 1.01 | 3.24 | +90.5% |
| Sample B | 45% | 0.961 | 2.95 | +73.5% |
| Sample C | 60% | 0.964 | 2.5 | +47.0% |

Table 12 below lists values for the dart drop testing for the samples. The values are normalized based on thickness. The testing demonstrates that the dart drop values for Samples A, B, and C are significantly improved to the Control Samples with marginal differences in the values.

| | % | Avg. Thickness | Dart Drop | Comparison to |
|---|---|---|---|---|
| Sample | PCR | in Mils | in g/mil | Control Samples |
| Control Sample | 0% | 1.056 | 93.8 | N\|/A |
| Sample A | 30% | 1.01 | 126.7 | +35% |
| Sample B | 45% | 0.961 | 138.9 | +48% |
| Sample C | 60% | 0.964 | 124.5 | +33% |

The data and results from the foregoing testing demonstrate that thin multilayer films can be made with a significant PCR plastic content while maintaining either comparable mechanical properties or acceptable mechanical properties or improving some of the properties as compared to thin multilayer films made from stock plastic resins.

Dart Value was measured as per ASTM D1709 Method A (26 inch) test procedure. Tensile tests in both machine and transverse directions were conducted using ASTM D882 test method. Tear tests in both machine and transverse directions were done in accordance with ASTM D1922 test method.

The films mentioned here are made by using the standard 3-layer coextrusion blown film process. The line is typically used to make trash bag film run on an 10″ die at 39.5″ wide. Three extruders feed the 3-layer line. They are called A, B, C extruders. This is a 3-layer line with 20% A-layer (inside skin), 60% B layer (core) and 20% C layer (outside skin). Film thickness extruder ranged from 0.9 to 1.1 mil. Temperature range is 345 to 400° F. in the extrusion system. Run rate is approximately 330 pounds per hour at 160 feet per minute. In this run, PCR was added in the core (B-extruder).

We claim:

1. A multilayer film comprising at least two layers,
at least one skin layer comprising a polyolefin having a density of from about 0.850 g/cc to 0.970 g/cc and a melt index of from about 0.5 g to about 3 g/10 min at 190° C./2.16 kg, and
a core layer comprising post-consumer recycled (PCR) low density polyethylene polymer,
wherein the overall post-consumer recycled content of the multilayer film ranges from 20% to 90%, and
wherein the overall film thickness of the multilayer film ranges from about 0.2 mil to 10 mils.

2. The multilayer film of claim 1, wherein the materials used to form the multilayer film are linear low-density polyethylene (LLDPE), a linear low-density polyethylene with a high melt flow index (LLDPE-HMFI), a slip additive, a PCR plastic recycled from white pigmented plastics, and a PCR plastic recycled from unpigmented plastics.

3. The multilayer film of claim 1, wherein the at least one outer skin layer or the core layer of the multilayer film comprises at least one of a low-density polyethylene, a metallocene catalyzed polyethylene (mPE), a linear low-density polyethylene (LLDPE), a low-density polyethylene (LDPE), a medium-density polyethylene (MDPE), a high-density polyethylene (HDPE), a virgin polyolefin copolymers, a post-consumer recycled polyethylene polymer, or a postindustrial recycled polyethylene polymer, hexene linear low-density polyethylene (hex-LLDPE), a linear low-density polyethylene with a high melt flow index (LLDPE-HMFI), a PCR plastic recycled from white pigmented plastics, and a PCR plastic recycled from unpigmented plastics.

4. The multilayer film of claim 1, wherein the film further comprises three layers, wherein first and third skin layers surround and enclose a second, core layer.

5. The multilayer film of claim 3, wherein the second, core layer of post-consumer recycled linear low density polyethylene polymer having at least 0.25 melt flow index (MFI).

6. The multilayer film of claim 3, wherein the first and third skin layers are each about 0.2 mils in thickness and the core layer is about 0.6 mils in thickness so that the multilayer film is about 1.0 mils in thickness.

7. The multilayer film of claim 3, wherein the second, core layer comprises between about 20% and 100% post-consumer recycled (PCR) content.

8. The multilayer film of claim 7, wherein the multilayer film as a whole comprises between about 30% and about 60% post-consumer recycled (PCR) content.

9. The multilayer film of claim 7, wherein the core layer comprises a mixture of PCR plastic recycled from white pigmented plastics, and a PCR plastic recycled from unpigmented plastics.

10. The multilayer film of claim 8, wherein the core layer comprises a mixture of about 50% PCR plastic recycled from white pigmented plastics, and about 50% PCR plastic recycled from unpigmented plastics.

11. The multilayer film of claim 1, wherein the film further comprises five layers wherein first and third skin layers surround a second, core layer comprising post-consumer recycled linear low density polyethylene polymer and the third and fifth skin layers surround a fourth, core layer comprising post-consumer recycled linear low density polyethylene polymer.

12. The multilayer film of claim 1, wherein the film further comprises seven layers wherein first and third skin layers surround a second, core layer comprising post-consumer recycled linear low density polyethylene polymer, the third and fifth skin layers surround a fourth, core layer comprising post-consumer recycled linear low density polyethylene polymer; and the fifth and seventh skin layers surround a sixth, core layer comprising post-consumer recycled linear low density polyethylene polymer.

13. An article formed from the multilayer film of claim 1, the article comprising a trash bag, a pouch, a sachet, a consumer film, non-food and food packaging, an agricultural film, a greenhouse films, a silage or grain films, a mulch film, a grape film, a almond film, a poly pipe for irrigation, a geomembrane, a pond liner or a bunker cover.

14. A method of making a multilayer film comprising at least two layers, the film characterized by a skin layer comprising a polyolefin having a density of from about 0.915 g/cc to 0.950 g/cc and a melt index of from about 0.5 g to about 3 g/10 min at 190° C./2.16 kg, and a core layer comprising between about 20% to 100% post-consumer recycled (PCR) low density polyethylene polymer, and the method comprising a blown film process.

15. The method of claim 14, wherein the multilayer film comprises a linear low-density polyethylene (LLDPE), a linear low-density polyethylene with a high melt flow index (LLDPE-HMFI), a slip additive, a PCR plastic recycled from white pigmented plastics, and a PCR plastic recycled from unpigmented plastics.

16. The method of claim 14, wherein the multilayer film comprises three layers, wherein first and third skin layers surround and enclose a second, core layer and the blown film process comprises a three-layer coextrusion blown film process.

17. The method of claim 16, wherein the first and third skin layers are each about 0.2 mils in thickness and the core layer is about 0.6 mils in thickness so that the multilayer film is about 1.0 mils in thickness.

18. The method of claim 16, wherein the second, core layer comprises between about 20% and 100% post-consumer recycled (PCR) content.

19. The method of claim 16, wherein the multilayer film comprises between about 30% and 60% post-consumer recycled (PCR) content.

20. The method of claim 16, wherein the core layer of the multilayer film comprises a mixture of about 50% PCR plastic recycled from white pigmented plastics, and about 50% PCR plastic recycled from unpigmented plastics.
